(19) United States
(12) Patent Application Publication
(10) Pub. No.: US 2012/0244485 A1
(43) Pub. Date: Sep. 27, 2012

(54) HEATING SYSTEM WITH INTEGRATED HYDROGEN GENERATION

(76) Inventors: Shawn MIKUSKI, Brick, NJ (US); Jayson Eduard VAJDA, Rivas (NI); Stephen John GAYNES, McHenry, IL (US)

(21) Appl. No.: 13/417,802

(22) Filed: Mar. 12, 2012

Related U.S. Application Data
(60) Provisional application No. 61/466,714, filed on Mar. 23, 2011.
(60) Provisional application No. 61/537,894, filed on Sep. 22, 2011.

(51) Int. Cl. F27B 19/00

(52) U.S. Cl. 432/92

(57) ABSTRACT

A heating system for heating a liquid includes a fuel cell having a plurality of charged plates operatively positioned within the fuel cell. An electrolytic solution supply conduit is operatively connected to the fuel cell for supplying electrolytic solution to the fuel cell. In one embodiment, a water conduit supplies water to the fuel cell. The water in the electrolytic solution disposed between said charged plates is converted to H₂H₂O₂ gas. A torch is provided for receiving the H₂H₂O₂ gas. A heat exchanger is operatively positioned relative to the torch for receiving heat from the torch and supplying the heat to a manifold for heating a liquid. In one embodiment, the fuel cell and the electrolytic solution are disposed within a first chamber of a reservoir and a cooling fluid is disposed within the second chamber of the reservoir.

### CROSS REFERENCE TO RELATED APPLICATIONS

The present application claims priority to U.S. Provisional Patent Application No. 61/466,714 filed on Mar. 23, 2011 and 61/537,894 filed on Sep. 22, 2011 the entire contents incorporated by reference herein.

### BACKGROUND OF THE INVENTION

1. Field of the Invention

The present invention is directed to a heating system that employs an integrated H₂H₂O₂ generating fuel cell for producing a fuel for heating a heat exchanger for heating a liquid in a large vessel such as a swimming pool, spa or water fountain.

2. Description Of Background Art

There is a common need in the swimming pool and spa industry to heat large quantities of water in a swimming pool or spa to make for a more pleasurable swimming/bathing experience. This is normally accomplished by adding a furnace to the water filtration system. However, conventional heating systems normally consist of natural gas, liquid propane gas or electrical heating elements that are expensive to operate. In the alternative, a conventional heating system may rely on polymer solar panels that are dependent on daylight and exceptional weather conditions. Similarly, a conventional heating system may rely on a heat pump device which is dependent on warm air weather conditions.

Conventional furnaces that use gas and/or electricity can add heat to the water in a swimming pool or spa very quickly. However, conventional furnaces have a distinct disadvantage in that they must rely on a supplier of the primary fuel needed to heat the water. The suppliers of natural gas, liquid propane gas or electrical energy can raise the price to whatever the market will bear. Therefore, conventional furnaces are very expensive to operate. Polymer solar panels operate on sunlight and work without any additional outside energy. However, polymer solar panels lack the ability to quickly change the temperature of the liquid in the vessel they are heating. In addition, polymer solar panels are limited to producing heat only during sunlight hours, on sunny days and days without rain which also limits the effectiveness of the solar panels. Similarly, heat pumps function by extracting heat from outside warm air. In colder temperatures, heat pumps are ineffective at heating swimming pool water.

### SUMMARY AND OBJECTS OF THE INVENTION

According to an embodiment of the present invention, a heating system is provided that uses electrical power to create H₂H₂O₂ from water in an electrolytic solution by use of a fuel cell. The H₂H₂O₂ is then fed, without being stored, to a torch where it is ignited and provides heat to a heat exchanger. The heat exchanger then heats the liquid which passes through the exchanger via an independent pump, or a circulation pump of the vessel.

According to an embodiment of the present invention, a majority of the energy used in the heating system is generated directly by the fuel cell. Thus, it is not necessary to purchase fuel from a utility service at an ever increasing market price.

According to an embodiment of the present invention, a relatively small amount of electrical input is used to produce a relatively high amount of heat as compared to a conventional conductive heating unit.

According to an embodiment of the present invention, the heating system can be made to service a variety of sizes of various applications. The heating system may be scaled up or down to meet the heating time expectations of the consumer.

According to an embodiment of the present invention, the fuel cell is not susceptible to output loss at high temperatures as compared to other fuel cells. The fuel cell according to the present invention employs an independent pump, a circulation pump and/or a filter/pump combination to run the liquid from the vessel around the fuel cell to cool the fuel cell. In addition, the excess thermal output from the hydrogen generation in the fuel cell is used to heat the liquid that is returned to the vessel.

According to an embodiment of the present invention, hydrogen is not stored or pressurized. H₂H₂O₂ gas is generated based on the need and size of the system.

According to an embodiment of the present invention, the heating system can be used at any time and is not limited to sunlight hours or to warm air conditions. This is to be contrasted to the operation of polymer solar panels which require direct sun light and to the operation of heat pumps which require a certain temperature of ambient air to be effective. Thus, the present invention can operate and generate heat on a twenty-four hour basis, on a cloudy day and on a rainy day or cold day.

According to an embodiment of the present invention, the heating system also has the ability to replace large and inefficient natural gas and propane fired heaters. Thus, energy savings are achieved while utilizing the most prevalent source of fuel in the world, hydrogen.

According to an embodiment of the present invention, the heating system includes a reservoir divided into at least a first chamber and a second chamber. A fuel cell includes a plurality of charged plates with the fuel cell being operatively positioned within the first chamber of said reservoir. Water and an electrolytic solution are disposed within the first chamber of the reservoir for supplying water and the electrolytic solution to the fuel cell. A cooling fluid is disposed within the second chamber of the reservoir for cooling the fuel cell. The water and the electrolytic solution are disposed between said charged plates and the water is converted to H₂H₂O₂ gas. A torch is provided for receiving the H₂H₂O₂ gas wherein a heat exchanger operatively positioned relative to the torch receives heat from the torch for supplying the heat to a manifold for heating a liquid.

According to an embodiment of the present invention, the heating system further includes a reservoir top positioned on a top surface of the reservoir for closing the reservoir and a bracket secured to the reservoir top for positioning the fuel cell within the first chamber in the reservoir.

According to an embodiment of the present invention, the heating system further includes a supply conduit with a shut off valve and an outlet conduit with a shut off valve operatively connected to said second chamber in said reservoir and a supply conduit with a shut off valve and an outlet conduit with a shut off valve operatively connected to said first chamber in said reservoir.

According to an embodiment of the present invention, the heating system for heating a liquid includes a fuel cell having a plurality of charged plates operatively positioned within the fuel cell. An electrolytic solution supply conduit is operatively connected to the fuel cell for supplying electrolytic solution to the fuel cell. A thermoelectric device is operatively positioned relative to the fuel cell for selectively cooling or heating solution. The water in the electrolytic solution disposed between the charged plates is converted to H₂H₂O₂ gas and is supplied to a torch with a heat exchanger operatively positioned relative to the torch for receiving heat from the torch and supplying the heat to a manifold for heating a liquid.

According to an embodiment of the present invention, the heating system further includes a thermostat operatively connected to the thermoelectric device for controlling the cooling or heating of the electrolytic solution.

According to an embodiment of the present invention, the heating system for heating a liquid includes a fuel cell having a plurality of charged plates operatively positioned within the fuel cell. A reservoir supplies electrolytic solution to the fuel cell. A thermoelectric device is operatively positioned relative to the reservoir for selectively cooling or heating the electrolytic solution. The water in the electrolytic solution disposed between the charged plates is converted to H₂H₂O₂ gas which is supplied to a torch with a heat exchanger operatively positioned relative to the torch for receiving heat from the torch and supplying the heat to a manifold for heating a liquid.

According to an embodiment of the present invention, the heating system further includes a thermostat operatively connected to the thermoelectric device for controlling the cooling or heating of the electrolytic solution.

According to an embodiment of the present invention, the heating system for heating a liquid includes a fuel cell having a plurality of charged plates operatively positioned within the fuel cell. An electrolytic solution supply conduit is operatively connected to the fuel cell for supplying electrolytic solution to the fuel cell. A radiator is operatively connected to the heating system for cooling the electrolytic solution. A fan is provided for supplying a flow of air to the radiator for cooling the radiator. The water in the electrolytic solution disposed between the charged plates is converted to H₂H₂O₂ gas that is supplied to a torch with a heat exchanger operatively positioned relative to the torch for receiving heat from the torch and supplying the heat to a manifold for heating a liquid.

According to an embodiment of the present invention, the fuel cell may be for use in a heating system for heating a liquid wherein a first outer plate is provided with a predetermined length and width. A second outer plate is provided with a predetermined length and width. A plurality of charged plates are operatively positioned between the first outer plate and said second outer plate. The plurality of charged plates are oversized relative to the first and second outer plates to include a heat exchange area that projects past the predetermined length and width of the first and second outer plates;. A conduit is provided for supplying water and an electrolytic solution to said fuel cell wherein the water and the electrolytic solution are disposed between said charged plates and the water is converted to H₂H₂O₂ gas.

According to an embodiment of the present invention, the heating system for heating a liquid includes a fuel cell having a plurality of charged plates operatively positioned within said fuel cell. A reservoir is operatively connected to the fuel cell for supplying electrolytic solution to the fuel cell. An evaporator is operatively positioned within the reservoir for cooling the electrolytic solution. A metering device, a dryer, a condenser and a compressor are operatively connected to the evaporator for supplying a compressed gas for cooling the evaporator and for cooling the electrolytic solution;

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of the heating system according to an embodiment of the present invention;

FIG. 2 is a schematic view of the reservoir with a heat exchanger being positioned within and the H₂H₂O₂ being discharged therefrom;

FIG. 3 is a schematic view of the an embodiment of the heating system according to the present invention;

FIG. 4 is a flow chart illustrating the steps in the heating of the liquid in the heating system of the present invention;

FIG. 5 is a schematic view of a rectifier bridge and a cooler for use in the present invention;

FIG. 6 is a top view of the rectifier bridge and cooler illustrated in FIG. 5;

FIG. 7 is view of a fuel cell illustrating a cooling conduit disposed within;

FIG. 8 is an exploded view of the fuel cell illustrated in FIG. 7;

FIG. 9 is a schematic view of the heating system according to an embodiment of the present invention wherein the warm liquid from the reservoir is supplied to the fuel cell;

FIG. 10 is a schematic view of the heating system according to an embodiment of the present invention wherein the warm liquid from the reservoir is supplied to the rectifier bridge cooling device;

FIG. 11 is a view of the torch showing the arrangement for fitting together with the heat exchanger;

FIG. 12 is a top view of the torch;

FIG. 13 is a flow chart setting forth the steps in the operation of a mechanical control of the conductivity of the electrolyte in the reservoir;

FIG. 14 is a flow chart setting forth the steps in the operation of an electrical control of the conductivity of the electrolyte in the reservoir;

FIG. 15 is a schematic view of an integrated reservoir and the fuel cell being combined into a single unit;

FIG. 16 is an exploded view of the various components of the integrated reservoir and the fuel cell;

FIG. 17 is a schematic view of the heating system according to a second embodiment of the present invention wherein an integrated reservoir and fuel cell are utilized;

FIG. 18 is a view of the integrated reservoir and fuel cell in a closed condition with shut off valves being operatively connected to the conduits supplying/discharging fluid therefrom;

FIG. 19 is a schematic view of the reservoir with an embodiment of a heat exchanger with a thermoelectric device being positioned within the reservoir for selectively heating or cooling the electrolytic solution;

FIG. 20 is a schematic view of an embodiment wherein a radiator and fan are operatively connected to the integrated reservoir and the fuel cell unit for cooling the electrolytic solution;

FIG. 21A is a schematic view of an embodiment wherein a radiator and fan are operatively connected to the fuel cell for cooling the electrolytic solution;

FIG. 21B is a schematic view of an embodiment wherein a radiator and fan are operatively connected to the reservoir for cooling the electrolytic solution;

FIG. 21C is a schematic view of an embodiment wherein a radiator and fan are operatively connected to the integrated reservoir and the fuel cell unit for cooling the electrolytic solution that is pumped into the radiator;

FIG. 22 is a view of the positively and negatively charged plates acting as a heat sink;

FIG. 23 is a view wherein gaskets are positioned between the positively and negatively charged plates thereby producing a heat sink effect; and

FIG. 24 is a schematic view of an embodiment that employs compressed vapor cooling to cool the electrolytic solution in the integrated reservoir and the fuel cell unit.

### DETAILED DESCRIPTION OF THE PREFERRED EMBODIMENTS

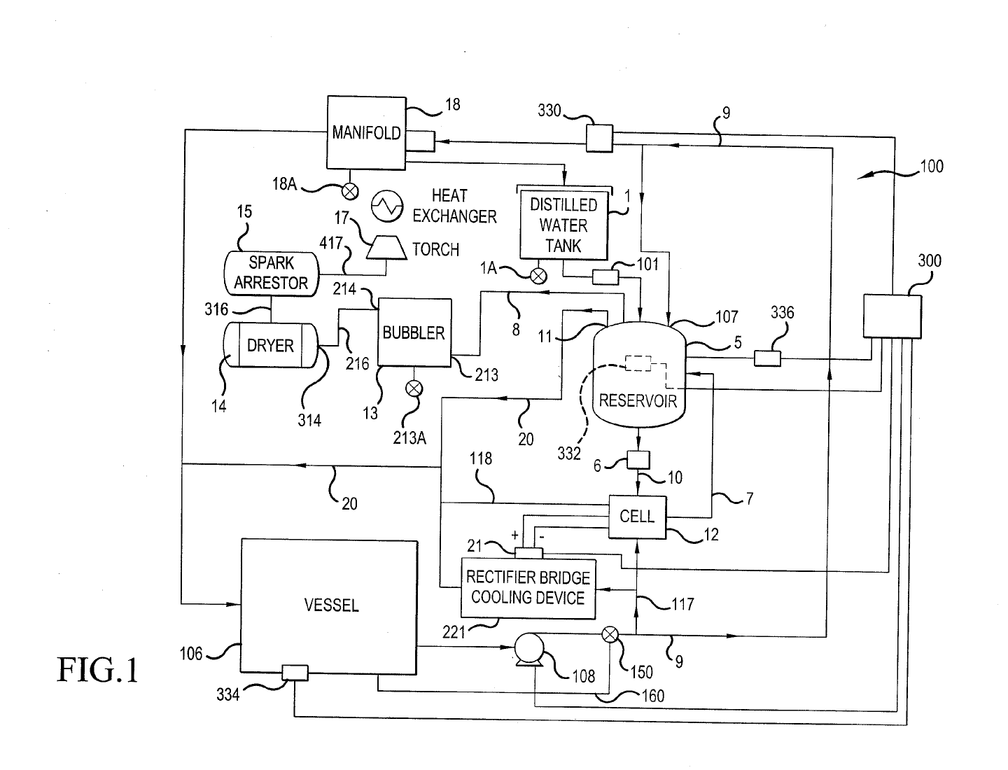

As illustrated in FIGS. 1-3, a heating system 100 is provided for heating a liquid. The heating system 100 includes a water tank or a distilled water tank 1 for holding distilled water that will be added to a reservoir 5 via a peristaltic pump, centrifugal pump or any suitable pump 101 (hereinafter referred to as a pump) which will transfer the distilled water from the distilled water tank 1 to an area adjacent to the bottom of the reservoir 5 containing the water in the electrolytic solution. The use of the pump 101 will maintain the electrolytic solution in the reservoir 5 at an optimum conductivity level. Distilled water in the tank 1 will be replenished by adding more distilled water to the tank manually through the opening 3. In addition, distilled water may also be captured in the torch and manifold area from the combustion of the H₂H₂O₂ fuel as well as the condensation created in the manifold and pumped back to the distilled water tank 1 with a pump.

The pumps 101 and 102 can be powered by an AC or DC electricity source. In the alternative, the pumps 101 and 102 can be powered by electricity generated by a hydroelectric device powered by a circulation pump 108 of a vessel 106.

The reservoir 5 will perform several functions. The first function will be to hold and contain the electrolytic solution. The water in the solution will be used to create the H₂H₂O₂ gas. After the water in the electrolytic solution is supplied to the fuel cell and H₂H₂O₂ gas is generated from the water, the reservoir 5 will also be used to collect the H₂H₂O₂ gas. A pump 6 will ensure that the electrolytic solution which is pumped from the reservoir 5 and through the fuel cell 12 will continually bring fresh electrolyte to be supplied to the fuel cell 12 for conversion of the water within the electrolytic solution to H₂H₂O₂ gas. A conduit 10 located at the bottom of the reservoir 5 permits the electrolytic to be pumped into the cell 12.

A second conduit 7 will exit at the top of the fuel cell 12 to permit electrolyte as well as H₂H₂O₂ gas created in the fuel cell 12 to enter the reservoir 5 from a second location at the bottom of the reservoir 5. The electrolyte will continue to circulate through the system while the H₂H₂O₂ gas rises through the electrolytic solution in the reservoir 5 and escapes into a conduit 8 at the top of the reservoir 5. The H₂H₂O₂ gas will be supplied to a bubbler 13.

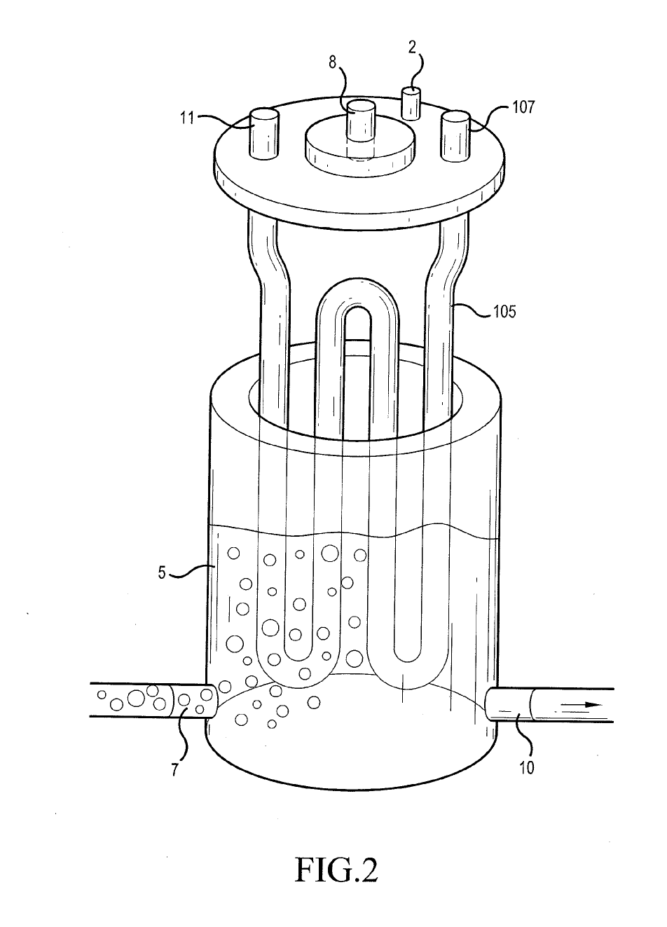

As illustrated in FIG. 2, the reservoir 5 will also cool the electrolyte by means of having a heat conductive cavity or tubing that forms a heat exchanger 105 mounted within the reservoir 5. This heat exchanger 105 will draw heat out of the electrolyte in the reservoir 5 thereby cooling the reservoir 5 while simultaneously adding heat to the liquid from the vessel 106. An inlet 107 at the top of the reservoir 5 permits a cool liquid to be pumped from the vessel 106 using the pump 108 to supply the cool liquid from the conduit 9 to the heat exchanger 105. The heat exchanger 105 will have fluid from the vessel 106 being pumped through the heat exchanger 105 by the pump 108 to thereby cool the electrolytic solution while heating the liquid from the vessel 106. The liquid in the heat exchanger 105 will then exit from a conduit 11 and will flow to either the cooling system of the fuel cell 12 where the liquid will also pass through another heat exchanger or into a warm liquid return manifold 20 where the heated liquid will be sent back to the vessel 106.

The reservoir 5 will consist of a tank that will hold the electrolytic solution and capture the H₂H₂O₂ gas as it is created by the water in the fuel cell 12. The tank 5 will consist of two main parts. The lower section is a container that will hold the electrolytic solution and will have two points of entry at the bottom. One will allow fresh cooled electrolyte to be pumped out through the conduit 10 and into the fuel cell 12. The second will allow electrolyte and H₂H₂O₂ gas from the fuel cell to travel back into the reservoir 5 by way of the conduit 7.

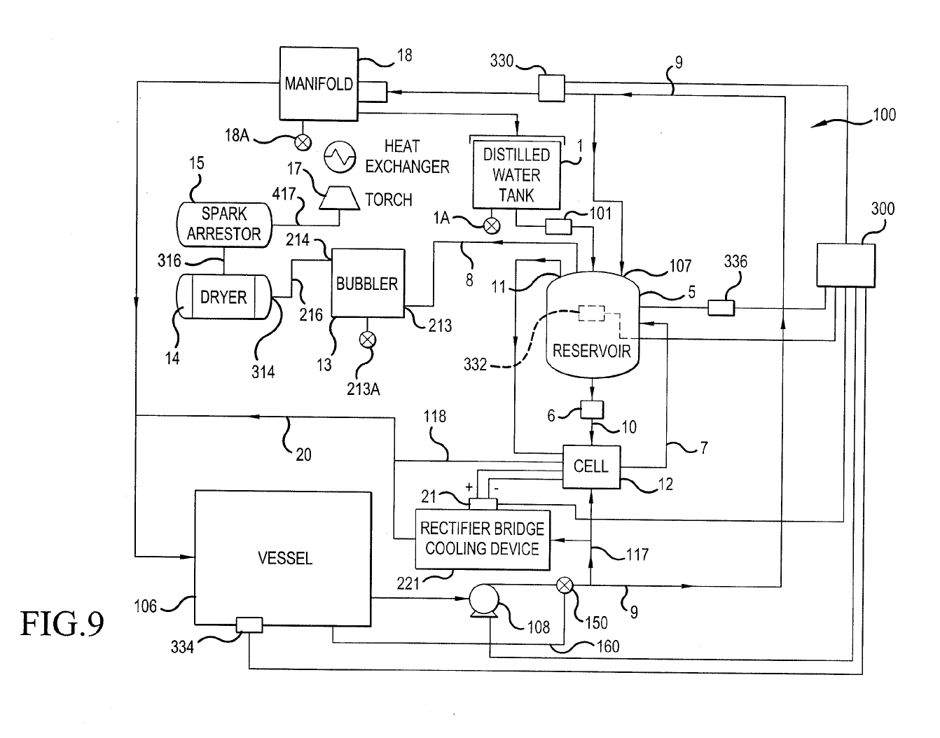

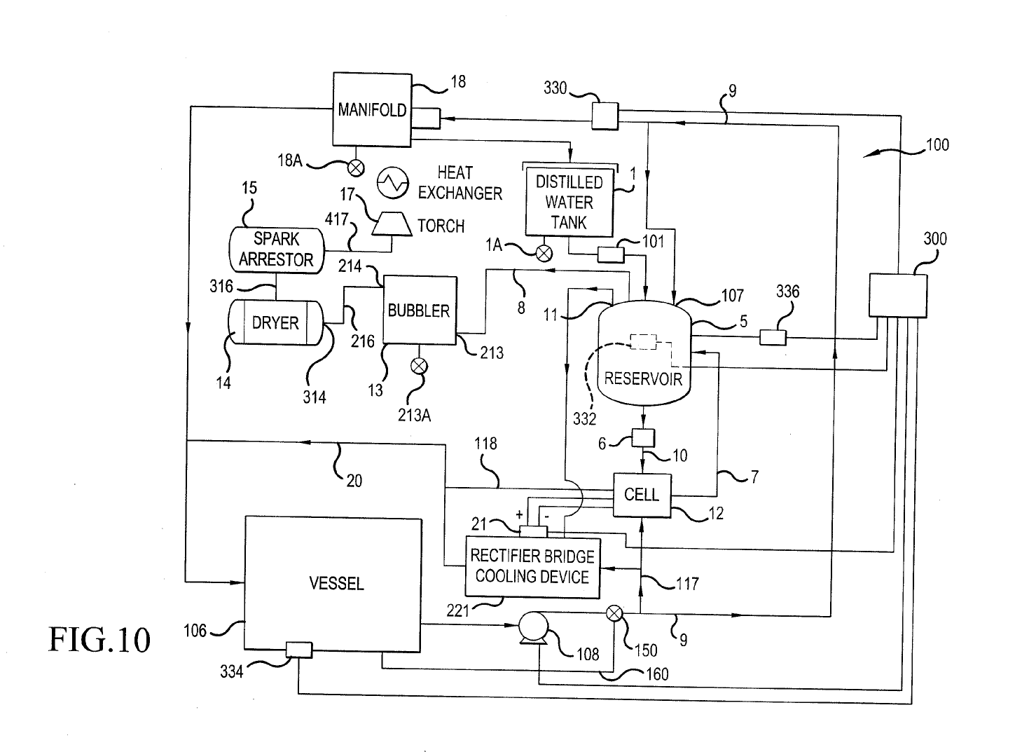

The top section of the reservoir 5 will make a water tight seal when it is bolted, sealed or otherwise secured to the lower section. It will have four points of entry. At the highest point is the exit that will allow the H₂H₂O₂ gas to escape the reservoir 5 by way of the conduit 8 and continue through the system. Another entry point will allow distilled water from the distilled water tank 1 to be pumped into the reservoir 5 by way of the conduit 2. This will be controlled by a pump 101 to maintain optimum conductivity of the electrolyte. The final two entry points will be connected together internally to a heat exchanger 105 that will be submerged in the electrolyte when the top and bottom sections of the reservoir 5 are joined. The pathway in the heat exchanger 105 will have liquid from the vessel 106 that is to be heated forced through the heat exchanger 105 by the pump 108. One side will be an inlet 107 for the cool liquid from the vessel 106 and the other side will be an outlet 11. The inlet side 107 will be fed from a cool liquid manifold that will draw cool liquid from the main piping and force the liquid through the heat conductive piping of the heat exchanger 105. As illustrated in FIG. 1, the liquid may exit the other outlet 11 and be connected to the warm liquid conduit 20 for being returned to the vessel 106. This system will cool the electrolyte while heating the liquid from the vessel 106. As illustrated in FIG. 9, the other outlet 11 may be connected to the cooling liquid for the fuel cell 12 and then connected to the outlet conduit 118 and thereafter to the warm liquid conduit 20 to be returned to the reservoir 106. As illustrated in FIG. 10, the other outlet 11 may be connected to the heat sink 221 of the rectifier bridge 21 and then returned to the warm liquid conduit 20 which will lead back to the vessel 106.

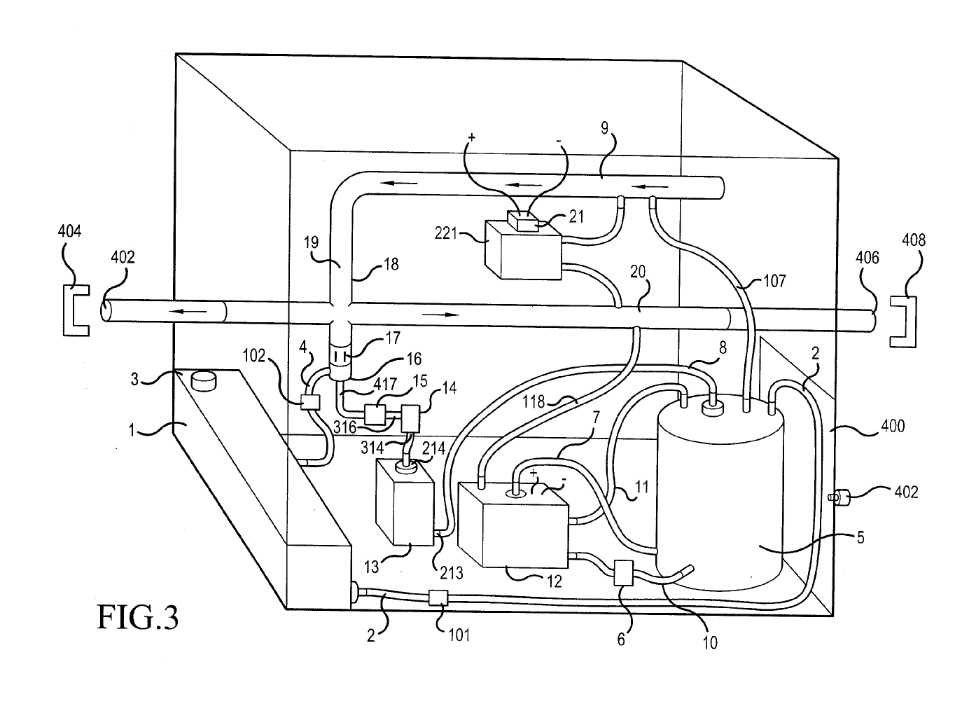

As illustrated in FIG. 3, the warm liquid conduit 20 may include two exit openings 402 and 406. If the heating system 100 is operatively connected to an existing flow passage from a vessel 106 that is inline, the exit opening 406 is closed by the cap 408. If the heating system 100 is operatively connected to an existing flow passage from a vessel 106 that requires a parallel return, the exit opening 402 is closed by the cap 404.

As illustrated in FIGS. 3, 5 and 6, a rectifier bridge 21 is used to convert AC voltage to DC voltage. Such a rectifier bridge 21 creates a significant amount of heat and is normally affixed to a heat sink 221 to dissipate the heat. The rectifier bridge 21 will be mounted to an insulated heat sink 221 which will be cooled by liquid from the vessel 106 to be heated. The insulated heat sink 221 will draw cool liquid from the cool liquid manifold 9 and circulate the liquid through the insulated heat sink 221 to cool the rectifier bridge 21. Thereafter, the liquid is sent back as warm liquid through the warm liquid conduit 20. This will add two advantages. The first advantage is that the liquid stream will cool the rectifier bridge 21 and the heat sink 221. The second advantage is that the liquid stream will heat the liquid in the stream that is thereafter supplied back to the vessel 106.

The rectifier bridge 21 will be used to convert AC voltage to DC. The cooler 221 includes an inlet 222 on one side for the cool liquid to enter the cooler 221. The liquid will be forced into the inlet 222 from the liquid conduit 117. The liquid will travel through the cooler 221 via a channel 227 in the cooler 221. The liquid will then pass out through the outlet 223 where the liquid will return the warm liquid to the vessel 106 via the warm liquid conduit 20. The rectifier bridge 21 will be attached to the cooler 221 by a fastener 226 and will screw directly into the cooler 221.

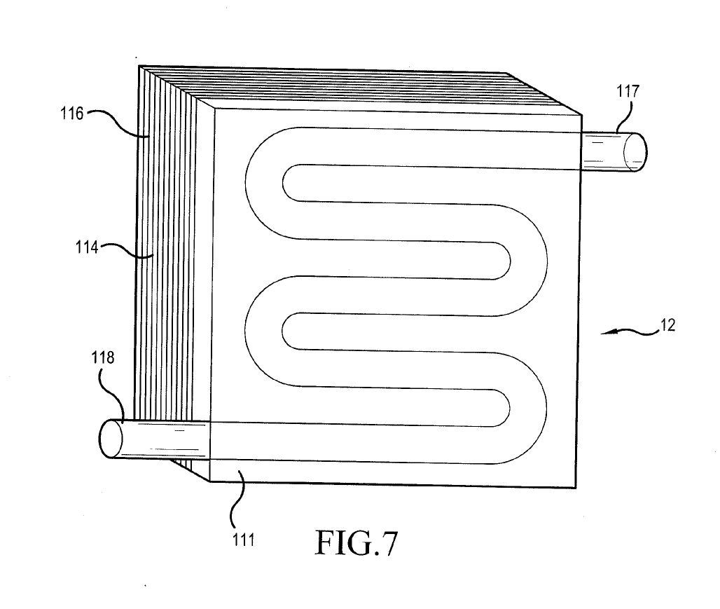

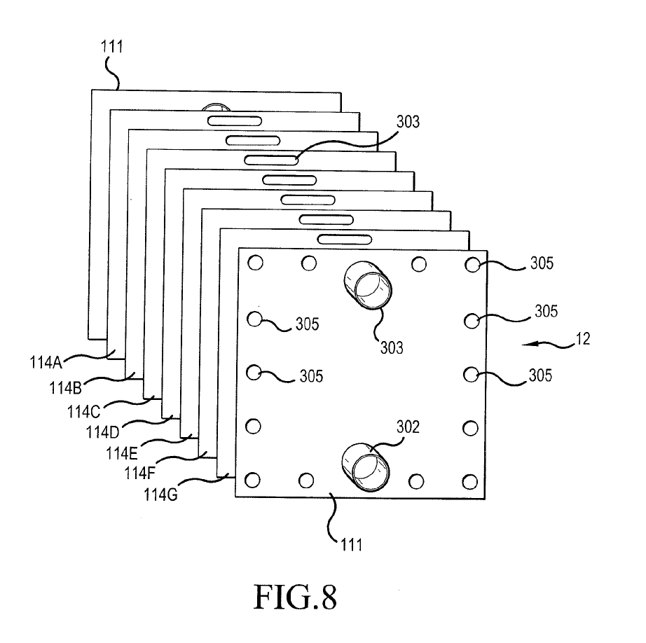

As illustrated in FIGS. 7 and 8, the fuel cell 12 uses a series of positively and negatively charged stainless steel plates 114A to 114G to create a field where electrolysis will take place. When the fuel cell 12 is energized and the solution is passed through the fuel cell 12 the water in the fuel cell creates oxyhydrogen or H₂H₂O₂. The H₂H₂O₂ gas is then forced back through the reservoir 5 via the conduit 7 with the electrolyte. The electrolyte will refill the reservoir 5 and the H₂H₂O₂ gas will rise to the top of the reservoir 5 where under its own pressure the H₂H₂O₂ gas will exit through a conduit 8 at the top of the reservoir 5. The H₂H₂O₂ fuel will then be supplied into the bubbler 13. The fuel cell 7 will be kept at a cool operating temperature by circulating cool liquid from the vessel 106 throughout the walls of the fuel cell through the inlet conduit 117 and out the outlet conduit 118. The cool liquid may come from the reservoir 5 or the cool liquid manifold 9.

As illustrated in FIG. 1, the bubbler 13 is a vessel which is filled with liquid and includes an entry point 213 for gas at the bottom and an exit point 214 for gas at the top. The main function of the bubbler 13 is to create a non-flammable buffer for the gas to travel through. Thus, if there is a failure at a torch 17 wherein the flame is inside the torch 17 and a blowback condition exists with the flames traveling back from the tip of the torch 17, no flame can enter the reservoir 5 or fuel cell 12 area of the heating system 100. This limits the possible damage to the components and increases safety. After the H₂H₂O₂ gas has made its way through the fuel cell 12 and the reservoir 5, the H₂H₂O₂ gas will pass through the bubbler 13. The gas will enter the liquid filled bubbler 13 from the bottom and rise to the top in the form of bubbles. The gas will collect at the top of the bubbler 13 and will be pushed by its own expanding pressure through a conduit 216 into a dryer 14.

The liquid in the bubbler 13 will act as a filter to keep impurities out of the fuel supply.

The dryer 14 consists of a multiple cavity device with several porous filters and a drain at the bottom. The drain at the bottom is of a petcock type for allowing moisture to be drained from the dryer 14. The dryer 14 is designed to eliminate most of the moisture which may be in the gas in order to create the hottest flame possible from the H₂H₂O₂. The moisture may be created by steam from the fuel cell 12. However, the use of the reservoir 5 and fuel cell 12 cooling system may negate the moisture. In addition, moisture may be created from liquid picked up in the bubbler 13. The H₂H₂O₂ gas will enter from a conduit 314 near the bottom of the dryer 14 and push through the varied chambers by its own expanding force and exit through a conduit 316 at the top of the dryer 14 and then will be supplied to a spark arrestor 15.

The dryer includes a mechanical float switch, an electric sensor or a magnetic float switch for determining if water in the moisture collecting chamber is above desired levels.

The spark arrestor 15 is a device for accepting the H₂H₂O₂ gas from the dryer 14 and creating a check valve for the flame. If a blowback condition exists and flames travel back from the tip of the torch 17, the spark arrestor 15 will smother the flame and stop the flame from backing up into the dryer 14. The spark arrestor 15 has an opening on one side that will accept a conduit from the dryer 14 that allows the H₂H₂O₂ gas to be pushed through the device by its own expanding force. The H₂H₂O₂ gas exits through a conduit 417 to supply the gas to the torch manifold 16 and the torch 17.

The spark arrestor 15 includes a mechanical and/or electrical sensor for determining and indicating when the spark arrestor 15 is nearing the end of its useful life and for determining when the spark arrestor 15 is past the end of its useful life for terminating power to the fuel cell 12.

The torch 17 shall have a conical point where the flame will be focused. There can be multiple arrays of torch points, or a single point in any application, depending on the heat exchanger or manifold used.

The torch tip is fitted closely into the manifold 18 and heat exchanger 19 to best transfer heat from the tip to the heat exchanger 19 and then to the liquid to be heated. The torch tip includes an integrated igniter to ignite the torch 17.

The H₂H₂O₂ gas travels from the spark arrestor 15 into the torch manifold 16 that will allow the gas to be directed to the torch 17 or multiple torches to be ignited by an electrical spark. The number of torches 17 and corresponding runners in the torch manifold 16 will be determined by the size of the unit and the amount of H₂H₂O₂ gas the system is sized to create. There will be no storage or pressurization of the H₂H₂O₂ gas. The torch manifold 16 will capture and channel any distilled water created by the ignition of H₂H₂O₂ gas as waste byproduct to send the distilled water back to the distilled water tank 1 by way of the conduit 4. This channel will also capture condensation created by the differing temperatures from the cool liquid running through the main heater manifold 18 and the heat created by the torches 17 and the heat exchanger 19 mounted within the main heater manifold 18. This captured distilled water will be pumped into the distilled water tank 1 through the conduit 4.

In one embodiment, the torches 17 may have a male thread on one side wherein the torches 17 may be screwed into the torch manifold 16 which will have a female thread. The torches 17 will fit into an aperture in the heat exchanger 19. The torch manifold 16 with the torches 17 installed is then bolted or otherwise attached to the main heat manifold 18. The H₂H₂O₂ fuel will be ignited in the torches 17 to heat the main heat exchanger 18 thereby heating the liquid supplied from the vessel 106. The combined heat exchanger 19 and complete torch manifold 16 will be bolted or otherwise attached to the main heater manifold 18.

The main heat exchanger 19 may be made with a hollow core. Around the outside of the hollow core are additional discs which will increase the contact area of the heat exchanger with the liquid supplied from the vessel 106. The torches 17 will ignite the H₂H₂O₂ gas where the gas will burn at a high temperature without the need of oxygen from the atmosphere. The core and the discs will heat the liquid as the liquid passes within the main heater manifold 18.

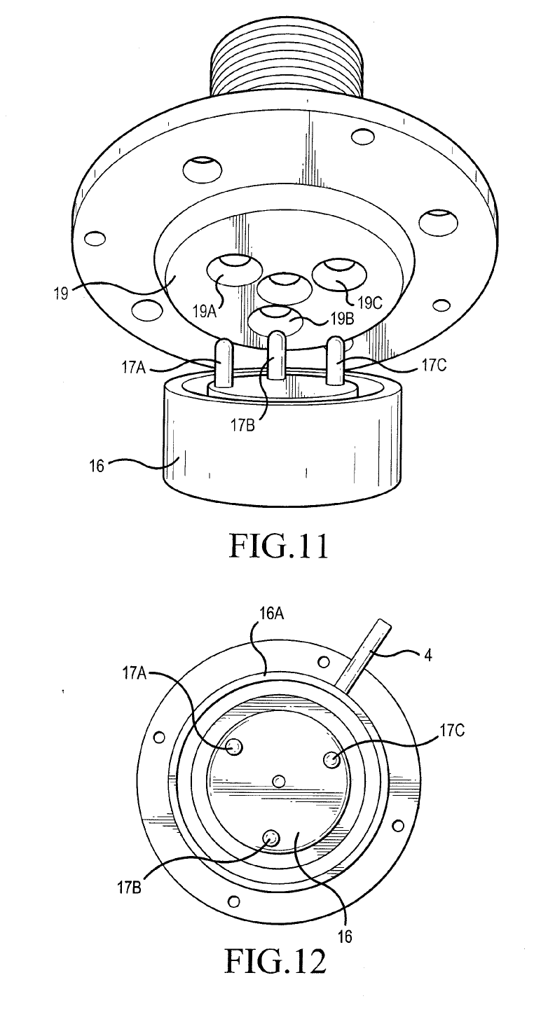

As illustrated in FIGS. 11 and 12, in one embodiment of the present invention three torches 17A, 17B and 17C are mounted on a torch manifold 16. The three torches 17A, 17B and 17C are fitted within apertures 19A, 19B and 19C in the main heat exchanger 19. Thus, all of the heat from the torches 17A, 17B and 17C is used in view of the fact that no external source of oxygen is necessary. The H₂H₂O₂ gas provides the necessary oxygen for burning the hydrogen. A collection ring 16A is formed on a surface of the torch manifold 16 for collecting distilled water that is formed as a by-product of the combustion of the H₂H₂O₂ gas. The distilled water in the collection ring 16A will be fed to the conduit 4 for return to the distilled water tank 1.

In a conventional heater using natural gas or liquid propane the burner would be displaced from the heat exchanger by a predetermined distance to permit a supply of oxygen to flow to the torch for burning the natural gas or liquid propane. A conventional heater would result in a loss of some of the heat in view of this arrangement.

The main heat manifold 18 will be attached to the main heat exchanger 19 by bolts or other means to secure the main heat manifold 18 and the main heat exchanger 19 with a water tight seal. The design places the main heat exchanger 19 into the main stream of liquid from the vessel 106 as the liquid passes through the main heat manifold 18. The liquid moves over the heat exchanger 19 heating the liquid as the liquid passes. The heated liquid is returned to the vessel 106. The main heat manifold 18 is designed with two returns but only one may be used at a time. The main heat manifold 18 will be supplied with a cap 404 or 408 that will close off one of the returns. This allows greater flexibility when plumbing the main heat manifold 18 into a pre-existing system. One choice is an inlet and outlet pipe on the same side 402 or 406 as is currently used on most swimming pool heaters. The other choice is a straight through configuration where the inlet is on one side and the outlet is on the opposite side 402 and 406.

The heat exchanger 19 and manifold 18 are the main transfer points of the thermal energy into the liquid being heated. The manifold 18 is an outer cavity with an inlet for fresh liquid to be heated, and an outlet for heated liquid to exit, and lastly an opening to insert and seal the heat exchanger 19. The heat exchanger 19 will be inserted directly into the flow of the liquid. When the torch 17 is fired it will cause the heat exchanger 19 to warm, thus warming the liquid passing around the heat exchanger 19.

The manifold 18 includes the heat exchanger 19 which will accept directly the flame from the torch tip. The heat exchanger 19 has an alternating protrusion pattern across a width of the heat exchanger 19 which, in one embodiment of the invention, will protrude roughly one half of an inch (1.27 cm) away from one side the heat exchanger 19. These protrusions from the heat exchanger 19 will alternate from side to side of the heat exchanger 19 and, in one embodiment of the invention, shall be spaced one quarter of an inch (0.635 cm) away from each other longwise so the liquid is forced into multiple contact points with the heat exchanger 19.

The protrusions from the heat exchanger 19 are in a spiral pattern to allow the liquid to swirl inside the heat exchanger 19 so the liquid comes into contact with as much of the heat exchanger 19 as possible.

The protrusions from the heat exchanger 19 are in a reverse curve pattern causing the liquid to double back on itself so the liquid is subjected to more time in the manifold 18 thereby gaining more heat.

The heat exchanger 19 shall be removable from the manifold 18 for easy maintenance. In addition, the heat exchanger 19 will have a bypass that will allow a predetermined amount of liquid to bypass the heat exchanger 19 by having differing size baffles. The heat exchanger 19 may have a bypass that will allow a predetermined amount of liquid to bypass the heat exchanger by having differing size pipe reducers.

The heat exchanger 19 may have a bypass that will allow an adjustable amount of liquid to bypass the heat exchanger 19 with the use of a scissor valve, ball valve, diverter valve, or butterfly valve. In another embodiment, the heat exchanger 19 may have a bypass that will allow a permanently fixed amount of liquid to bypass the heat exchanger 19. The heat exchanger 19 and manifold 18 can be constructed as one integral component to permit easy replacement of the whole unit.

In addition, when the heat exchanger is not being used, the heat exchanger 19 and manifold 18 may be removed from the system to extend the life of the heat exchanger 19. As illustrated in FIGS. 1, 9 and 10, a bypass valve 150 can be closed to permit the pump 108 and a filter system to be connected directly to the vessel 106 without circulating any liquid through the heating system 100.

Further, where winterization of the heating system 100 is required, a drain valve 1A, operatively connected to the distilled water tank 1, a drain valve 18A, operatively connected to the main heat manifold 18 and a drain valve 213A, operatively connected to the bubbler 13, are provided to drain liquid from the system.

The fuel cell 12 will take electrolyte from the reservoir 5 and pass the electrolyte over a series of positively and negatively charged plates 114A to 114G which have a predetermined amount of space between the plates 114A to 114G. In the space between the plates 114A to 114G an electrical field is provided where the electrolysis will take place. The result will be a release of H₂H₂O₂ gas which will be collected as fuel for the heating system.

The fuel cell 12 is commercially available and can be sized differently to generate the amount of H₂H₂O₂ required. There are two outside polymer plates 111 which have an entry hole 302 near the bottom of the fuel cell 12 to allow the electrolyte to be pumped into the fuel cell 12. Between the two polymer plates 111 the plurality of stainless steel plates 114A to 114G are spaced relative to each other. The stainless steel plates 114A to 114G also include the same holes 302 as the polymer plates 111 to allow ingress and egress of the electrolytic fluid. Between every plate 114A to 114G there is a gasket 116 which will create space between the plates 114A to 114G as well as make the unit water tight. The entire system is held together by a plurality of fasteners 305 that run through the plates 114A to 114G pulling the plates 114A to 114G together to provide a water tight seal.

The outside polymer plates 111 will have a cavity that will allow liquid from either the cool liquid conduit 117 to be pumped through the cavity cooling the fuel cell 12 as well as heating the liquid. As illustrated in FIG. 7, an inlet 117 is provided where the cool liquid will enter. An outlet 118 is provided where the warm liquid will exit. The cavity will be on both sides of the fuel cell and will return the liquid back to the warm liquid conduit 20 and then back to the vessel 106.

An electrical source is provided to cause an electrolysis in the water in the electrolytic solution that results in the creation of hydrogen and oxygen, H₂H₂O₂. The source of electricity may be from a solar panel, an electrical line of current, a DC power supply, or electricity created by a hydroelectric generator powered by a circulation pump of a vessel. A rechargeable battery or disposable battery may also be used separately or in conjunction with the solar panel, the electrical line of current, the DC power supply or the electricity created by the hydroelectric generator.

When DC voltage is applied to the fuel cell 12, the water in the electrolytic solution disposed between the properly spaced positively and negatively charged plates 114A to 114G creates H₂H₂O₂ in the form of a gas. As the water in the electrolytic solution passes through the space between the negative and positively charged plates 114A to 114G that create an electrical field the electrolysis will take place. The electrolysis creates the hydrogen and oxygen, H₂H₂O₂, mixture. The fuel cell 12 may be of a wet or dry type.

The electrical source can originate from either 220 volts AC or 110 volts AC as provided from a typical power grid. The current is converted to 6, 12, 24, 48, 60, 72, 84, 96, 108 or 120 volts by use of transformers and then rectified to a DC current. A 6, 12, 24, 48, 60, 72, 84, 96, 108, 120 volt DC deep cell battery or any suitable voltage DC battery may be used. The DC deep cell battery may be recharged by a solar vocative panel. In the alternative, the 6, 12, 24, 48, 60, 72, 84, 96, 108, 120 volt may be supplied by a single photo vocative panel or by an array of photo vocative panels. Further, the 6, 12, 24, 48, 60, 72, 84, 96, 108, 120 volt DC deep cell battery or any suitable voltage DC battery may be recharged by a circuit that is connected to an electrical line of current.

As an example, the rectifier bridge 21 may be operated at 4 to 15 amps at 100 to 130 volts DC to produce approximately 5 to 10 liters of H₂H₂O₂ gas per minute for supplying a substantial quantity of H₂H₂O₂ gas to the torch 17 for heating the heat exchanger 19. The present invention produces a substantial quantity of heat as compared to a conventional conductive heating unit. The use of 4 to 15 amps provides a relatively low energy source with a substantially high output of H₂H₂O₂ gas.

Any battery array either rechargeable or disposable that can be configured in a 6, 12 or 24 volt configuration may be used as the electrical source.

In addition, a power source of 220 volts AC or 110 volts AC of power may be operatively connected to a triad dimmer, reduced to 55 volts AC and then rectified to DC current. Further a power source of 110 volts AC of power may be operatively connected to a rectifier DC to a 52 plate fuel cell. In one embodiment 220 volts AC of power can be transformed to 110 volts AC and then rectified to DC power which is then applied to a 52 plate fuel cell.

An electrical current that is provided from any hydroelectric device that could be connected to the liquid circulation system of the vessel to create electricity may be used to power the fuel cell.

The electrical control system shall monitor the amperage that is being delivered to the fuel cell. If the amperage being drawn to the cell reaches a level above that for which it is rated, the electrical system will automatically cut off power to the fuel cell.

The cell circuitry includes a fuse or circuit breaker of a specified rating for the cell and power supply that shall blow if there is a rise in the amperage above that predetermined level.

The fuel cell 12 includes a mechanical pressure sensor that will trigger a shutdown of the system if backpressure of an undesirable level exists in the fuel cell 12. In the alternative, the fuel cell 12 may include an electrical pressure sensor that will trigger a shutdown of the system if backpressure of an undesirable level exists in the fuel cell 12.

The fuel cell 12 includes an emergency blowout valve which will vent the hydrogen from the fuel cell if a pressure above desired levels inside the fuel cell is reached.

The fuel cell 12 includes a mechanical safety which will alert and cut power to the fuel cell 12 if the electrolytic liquid is low in the fuel cell 12. In the alternative, the fuel cell 12 may include an electrical safety which will alert and cut power to the fuel cell 12 if the electrolytic liquid is low in the fuel cell 12.

The fuel cell includes a mechanical or electrical safety which will indicate visually to the operator that the electrolytic solution is low.

The fuel cell includes an electronic pulse modulation to control the overheating of the fuel cell if the overheating conditions exist.

The fuel cell includes a provision that if the ambient air temperature rises above a predetermined level, power to the fuel cell will be cut off

The reservoir 5 is constructed with pipes or veins similar to a radiator. The pipes extend into the reservoir 5 and come into contact with the electrolytic solution in the reservoir 5. Liquid from the vessel 106 being heated will be passed through the pipes using the circulating pump 108 of the vessel 106. The cool liquid passing through the pipes will wick away heat from the electrolytic solution, while adding heat to the liquid going back to the vessel 106.

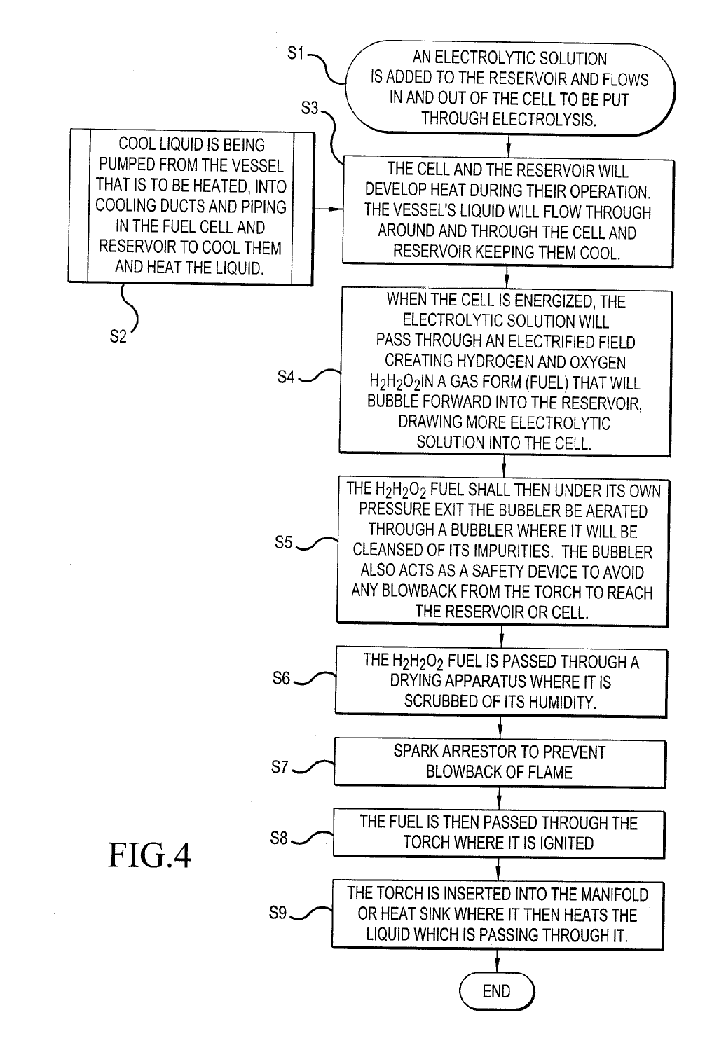

As illustrated in FIG. 4, step S1 takes an electrolytic solution and adds the solution to a reservoir 5. Step S2 is the cool liquid that is pumped from a vessel to be heated into the heating system. Step S3 utilizes the cool liquid from the reservoir for cooling the fuel cell 12 and the reservoir 5. Step S4 forms H₂H₂O₂ gas and sends the gas to the bubbler 13. Step S5 the H₂H₂O₂ gas is cleaned. Step S6 the H₂H₂O₂ gas is sent to a dryer. Step S7 the H₂H₂O₂ gas passes through a spark arrestor 15. In Step S8 the H₂H₂O₂ gas is passed through the torch 17 and ignited. Step S9 the torch 17 heats the heat exchanger 19 disposed within the manifold 18 for heating the liquid from the vessel 106.

The present invention does not store or pressurize the H₂H₂O₂ gas. The heating system 100 is sized for a particular vessel 106 to permit only a sufficient amount of H₂H₂O₂ gas which will be consumed by the torch 17. The H₂H₂O₂ gas is only generated based on the need and the size of the system. In addition, no blow back of the flame from the torch 17 back to the reservoir 5 will occur in view of the arrangement of the spark arrestor 15, the dryer 14 and the bubbler 13.

In addition, a control system 300 is used to monitor the flow of fluid in the conduit 9 by use of a flow switch 330 to turn off the pump 108 and the rectifier bridge 21 and all electrical equipment if the flow of fluid in the conduit 9 is below a predetermined volume.

The control system is operatively connected to a thermostatic 334 to turn off the pump 108 and the rectifier bridge 21 and all electrical equipment when the liquid within the vessel 106 is heated to a desired temperature.

Further, the control system 300 will monitor the level of electrolytic solution in the reservoir 5 by way of a float switch 332 or a switch operating on a sight panel in the reservoir 5 to refill the reservoir 5 with additional distilled water if the level of electrolytic solution is below a predetermined level.

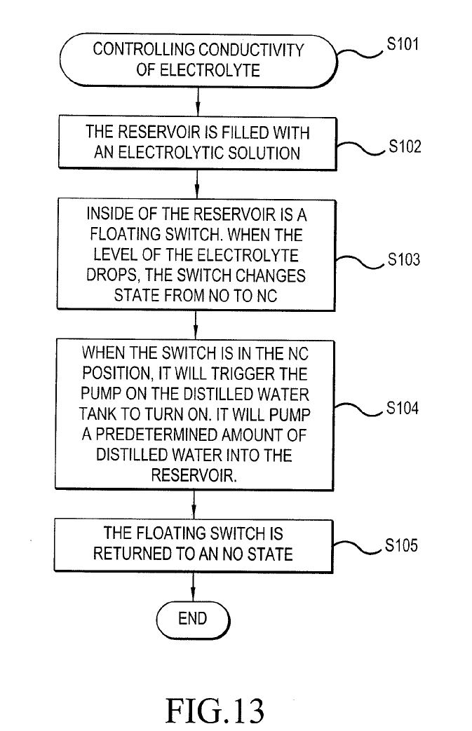

FIG. 13 sets forth a flow chart of the steps in the operation of a mechanical floating switch 332 for controlling the conductivity of the electrolyte in the reservoir 5. In Step 101 the control starts. Step 102 the reservoir 5 is filled with an electrolytic solution. Step 103 a floating switch 332 is positioned within the reservoir 5 for monitoring the level of electrolytic solution from NO to NC. Step 104 if the float switch 332 is positioned in the NC position, a controller 300 will turn on the pump 101 to pump a predetermined amount of distilled water into the reservoir 5. Step 105 if the floating switch 332 is returned to the NO state, the pump 101 is not activated.

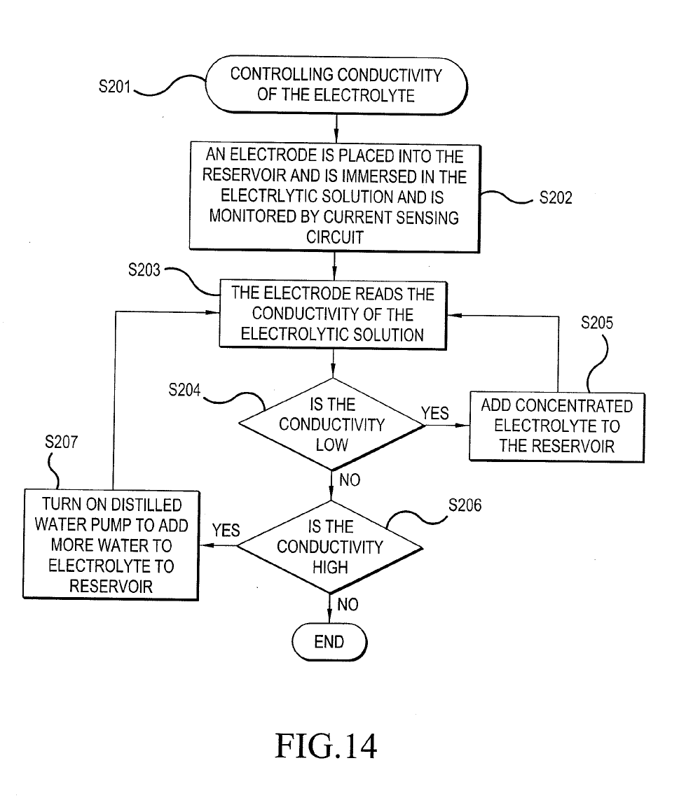

FIG. 14 is a flow chart setting forth the steps in the operation of an electrical control of the conductivity of the electrolyte in the reservoir 5. In this embodiment, the reservoir 5 would include an electrode immersed in the electrolytic solution in the reservoir wherein a current sensing circuit is monitored to determine the conductivity of the electrolytic solution. In Step 201 the control starts. Step 202 an electrode is placed in the reservoir 5 and is immersed in the electrolytic solution and is monitored by a current sensing circuit. Step 203 the electrode reads the conductivity of the electrolytic solution. Step 204 if the conductivity is low a signal is sent to Step 205 to add concentrated electrolyte to the reservoir 5. Step 206 determines if the conductivity is high. Step 207 turns on the pump 101 to add additional distilled water to the reservoir 5.

Further, the control system 300 will monitor the pressure within the reservoir 5 by way of a pressure switch 336 to turn off the pump 108 and the rectifier bridge 21 and all electrical equipment if the pressure rises above a predetermined level.

The use of low amperage in the range of 4 to 15 amps while producing the required amount of H₂H₂O₂ gas that is not stored within the heating system 100 provides a safe heating system 100 for industrial use or normal home use.

As illustrated in FIG. 3, an access door 400 with a handle 402 may be used to gain access to the components of the heating system to facilitate servicing and winterizing of the components.

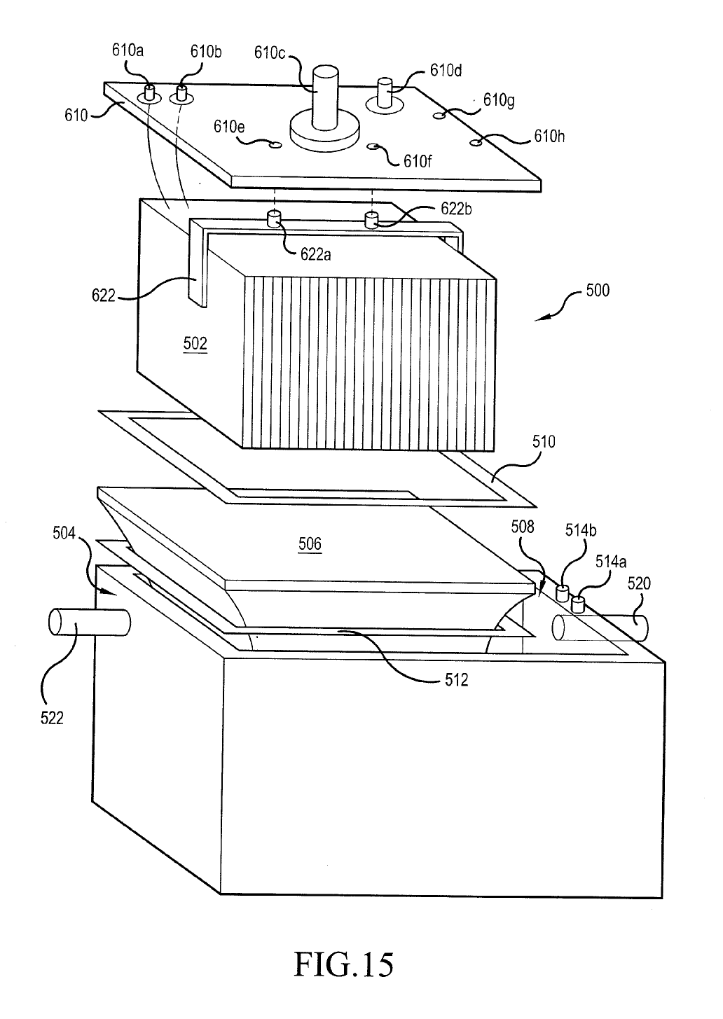

FIGS. 15-18 illustrate an embodiment of the invention wherein the reservoir 5 and the fuel cell 12, as illustrated in FIG. 1, have been combined into a single, integrated reservoir and fuel cell assembly 500. By constructing the integrated reservoir and fuel cell 501 as a single unit, the cost of manufacturing the unit is decreased, improved cooling of the reservoir/fuel cell occurs and the back pressure on the fluid circulation system is minimized. Further, the footprint of the combined reservoir fuel cell is decreased to provide a reduction in the required space for the unit.

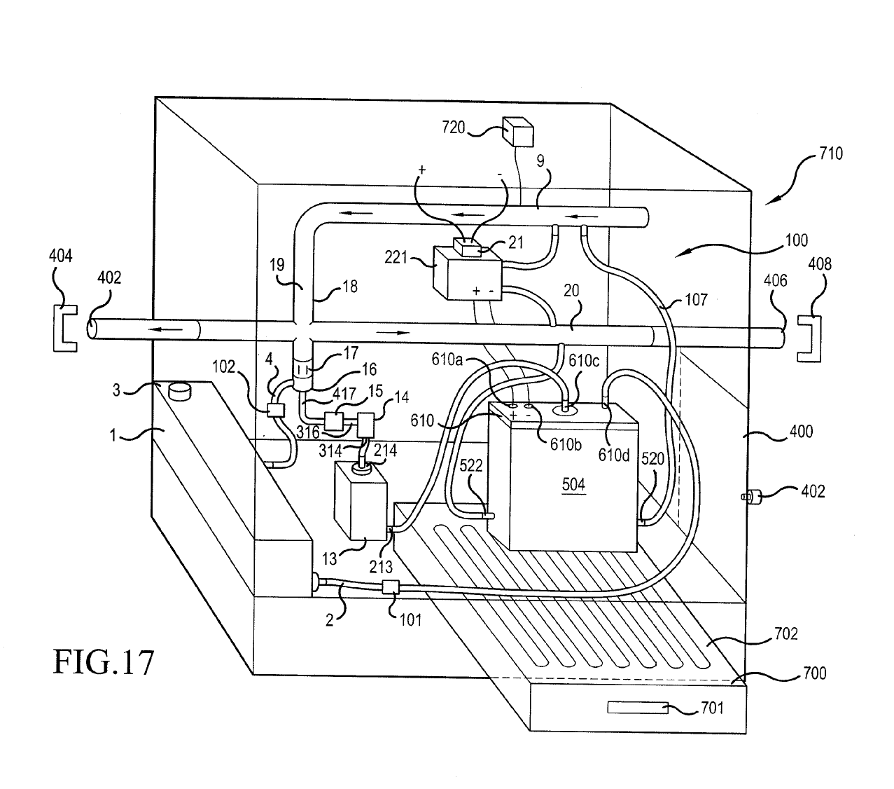

The embodiment illustrated in FIGS. 15-18 also eliminates the requirement for a pump to circulate the electrolytic solution between the reservoir and fuel cell. Safety is improved by reducing problems that may develop if a leak or rupture in the fuel cell or reservoir occurs. Further, as illustrated in FIG. 17, a hydrogen sensor 720 is provided to trigger a safety shutdown of the system.

The reservoir and fuel cell assembly 500 are combined into a single unit to also enable a savings of space inside an enclosure for the heating system. This is accomplished by placing the fuel cell 502 into a reservoir bottom 506, immersed in the electrolytic solution, rather than having a separate fuel cell 12 and a separate reservoir 5 as illustrated in FIG. 1. The reservoir 504 includes two different chambers, the reservoir bottom 506, and a fuel cell cooler 508. The fuel cell cooler 508 will hold the liquid from the vessel 106 that is being heated. The reservoir bottom 506 will hold the water in the electrolytic solution used to produce the H₂H₂O₂ fuel.

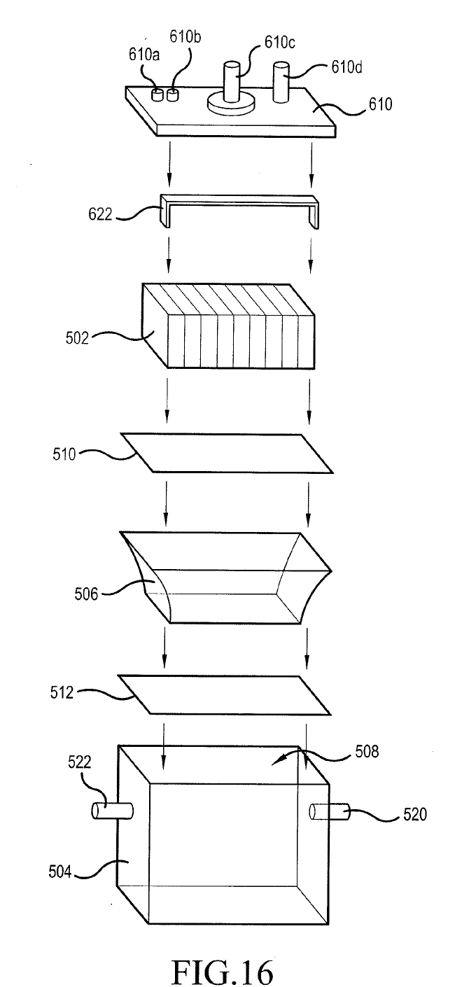

As illustrated in FIGS. 15 and 16 together with the heating system illustrated in FIGS. 1 and 17, a reservoir top 610 includes a negative terminal connection 610a and a positive terminal connection 610b for securing to the positive and negative connections from the rectifier bridge 21 connected to the cooler 221. The reservoir top 610 also includes an H₂H₂O₂ vent conduit 610c for allowing H₂H₂O₂ fuel created by the cell 502 to exit and make its way through the system to be burned by the torch 17. The reservoir top 610 also includes a distilled water entry conduit 610d for allowing fresh distilled water to enter the fuel cell chamber from the distilled water tank 1. In addition, a plurality of apertures 610g and 610h may be formed around the entire reservoir top 610 for receiving a corresponding individual fastener or a plurality of fasteners 514a, 514b formed around the top of the reservoir 504 for securing the reservoir top 610 to the reservoir 504.

Negative and positively charged plates 502 are suspended from the reservoir top 610 by a cell attachment bracket 622. The cell attachment bracket 622 can either be molded into the reservoir top 610 or attached by fasteners secured within the apertures 622a, 622b in the cell attachment bracket 622 and 610e and 610f in the reservoir top 610. When the cell attachment bracket 622 is bolted to the reservoir top 610, the conductive plates 502 will be submerged into the electrolytic solution to a predetermined level in the reservoir bottom 506. The reservoir bottom 506 is made of a heat conductive polymer or metal for holding the electrolytic solution. In this embodiment, a pump is not required to pump liquid through the fuel cell 12 as the H₂H₂O₂ bubbles rising from the charged plates 502 will cause convection, thereby circulating the electrolytic solution in the reservoir bottom 506. The electrolytic solution will come into contact with the reservoir bottom 506, and transfer heat through the reservoir bottom or chamber 506 into the liquid in the fuel cell cooler 508.

The fuel cell cooler 508 will accept the entire aforementioned assembly including the reservoir bottom 506 and the fuel cell 502 into a recess in the top of the fuel cell cooler 508. A gasket 510 creates a seal between the fuel cell cooler 508 and the reservoir bottom 506. Thus, a water and air tight seal is provided that will keep the contents of both respective chambers 506, 508 separate from each other.

The fuel cell cooler 508 includes a channel in the surface for receiving a gasket 512. The gasket 512 is also disposed within a channel around the rim of the reservoir bottom 506. The entire fuel cell assembly 500 is held together by a plurality of fasteners 514a, 514b positioned around the perimeter of the reservoir 504 and received in a plurality of apetures 610g, 610h formed around the perimeter of the reservoir 504. The fuel cell cooler 508 includes an inlet conduit 520 for enabling a flow of a cooling liquid from the vessel 106 to be pumped by the circulation pump 108 into the fuel cell cooler 508 for cooling the reservoir bottom 506 that includes the conductive plates of the fuel cell 502 disposed therein. The cooling liquid comes into contact with the underside of the reservoir bottom 506 thereby heating the liquid in the fuel cell cooler 508 while cooling the electrolyte in the reservoir bottom 506. The warmed liquid exits the reservoir 504 via an outlet conduit 522.

FIG. 17 is similar to FIG. 3 wherein like elements are referred to with the same reference numerals. Thus, a description thereof is omitted. As illustrated in FIG. 17, a safety catch or drawer 700 is disposed beneath the fuel cell assembly 500. The floor of the main cabinet 710 for positioning the fuel cell assembly 500 includes slots 702 or a grid wherein if a rupture occurs in the fuel cell cooler 508 or the fuel cell assembly 500, the electrolytic solution will flow through the slots 702 and into the safety catch or drawer 700. The safety catch or drawer 700 may include a predetermined amount of a neutralizing agent for returning the electrolytic solution to a suitable pH level rendering it neutral. The solution may then be disposed of safely and the unit can be repaired. The safety catch or drawer 700 includes a handle 701 for sliding out the safety catch or drawer 700 for easy removal and replacement. The removable safety catch drawer 700 slides into the bottom of the heater cabinet and is located directly under the reservoir and or under the fuel cell itself. The heater cabinet will include the slots 702 or a grid that will allow electrolytic solution from either the fuel cell 502 or the reservoir 504 or the reservoir and fuel cell assembly 500 to flow out of the heater cabinet and down into the drawer 700. The drawer 700 would have a predetermined amount of neutralizing agent in the drawer 700 which when mixed with the electrolyte would bring the ph to a neutral level. This would facilitate an easy cleanup of the electrolyte if the fuel cell 502 and or the reservoir 504 should rupture or leak.

In addition, as illustrated in FIG. 17 an electro mechanical device 720 for sensing the presence of hydrogen is positioned at the top of the cabinet 710. If the electro mechanical device 720 detects the presence of hydrogen in the cabinet 710, the electro mechanical device 720 will shut down all electricity to the heating system 100. This can be accomplished either through a software safety, mechanical safety, or a combination of both.

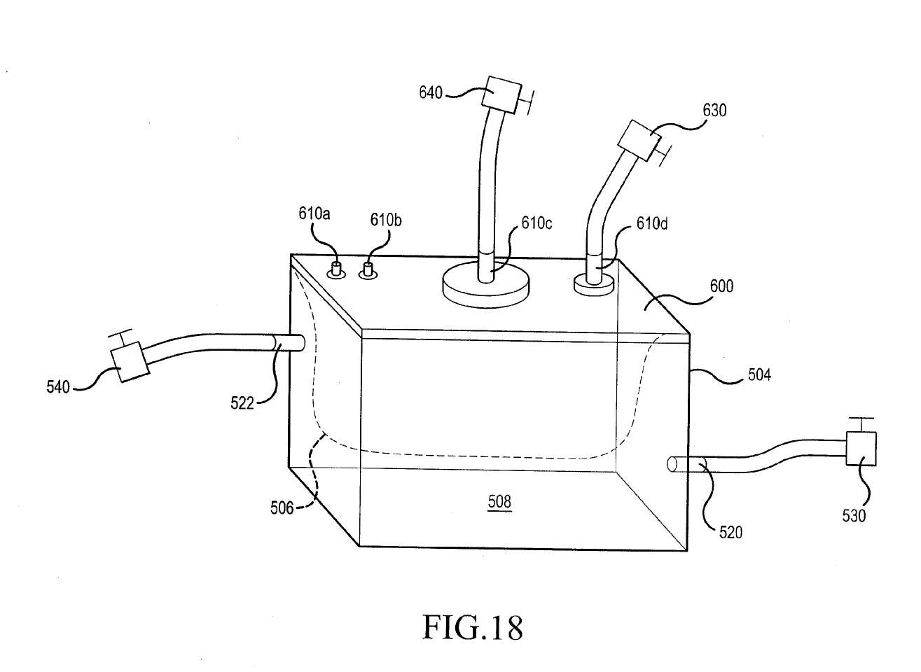

FIG. 18 illustrates a closed state with the reservoir top 610 positioned on the top of the reservoir 504. The distilled water entry conduit 610d for allowing fresh distilled water to enter the fuel cell chamber or reservoir bottom 506 from the distilled water tank 1 includes a shut off valve 630. The H₂H₂O₂ vent conduit 610c for allowing H₂H₂O₂ fuel created by the cell 502 to exit includes a valve shut off 640. The inlet conduit 520 includes a shut off valve 530. The outlet conduit 522 includes a shut off valve 540. The shut off valves 630, 640, 530, 540 enable a user to shut off all entrances and exits for liquids from the integrated fuel cell assembly 500. The shut off valves greatly increase the ease of service of the unit and cut down the time required to complete winterization if needed in cold climates. The shut off valves can also be used by service technicians to diagnose flow problems, or safety equipment. This can be accomplished by opening and closing the valves in a pre-described sequence and taking electronic and or pressure readings to determine failed components.

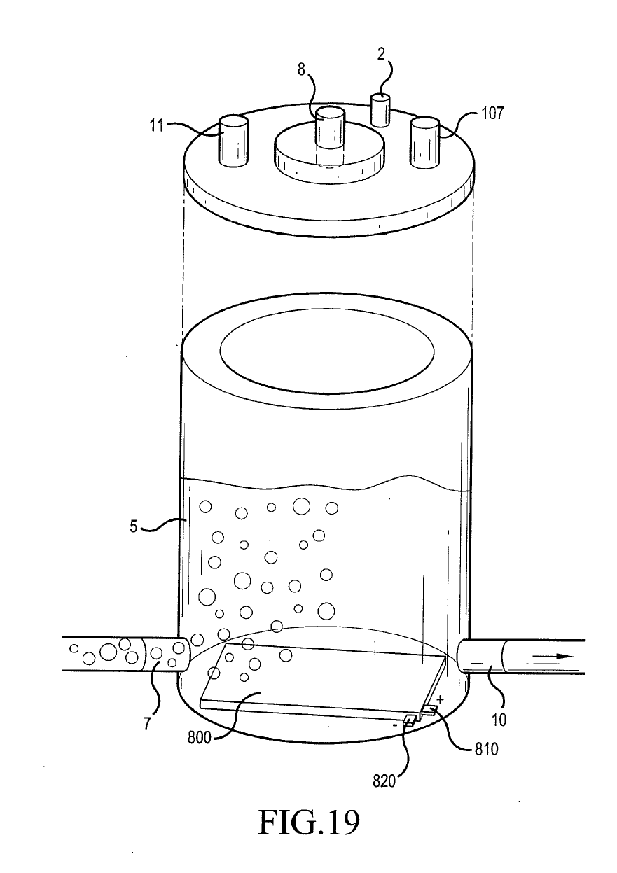

FIGS. 19-24 illustrate other embodiments of the liquid heating system 100 with improvements in the cooling of the fuel cell 12 and reservoir 5 with the electrolyte contained within. These embodiments enable the liquid heating system 100 unit to operate with smaller liquid containment vessels, and will eliminate the use of liquid within the vessel for cooling the electrolyte and fuel cell 12. These improvements will allow higher temperatures to be reached for enabling the liquid heating system 100 to be used in combination with conventional residential or commercial hot water heaters.

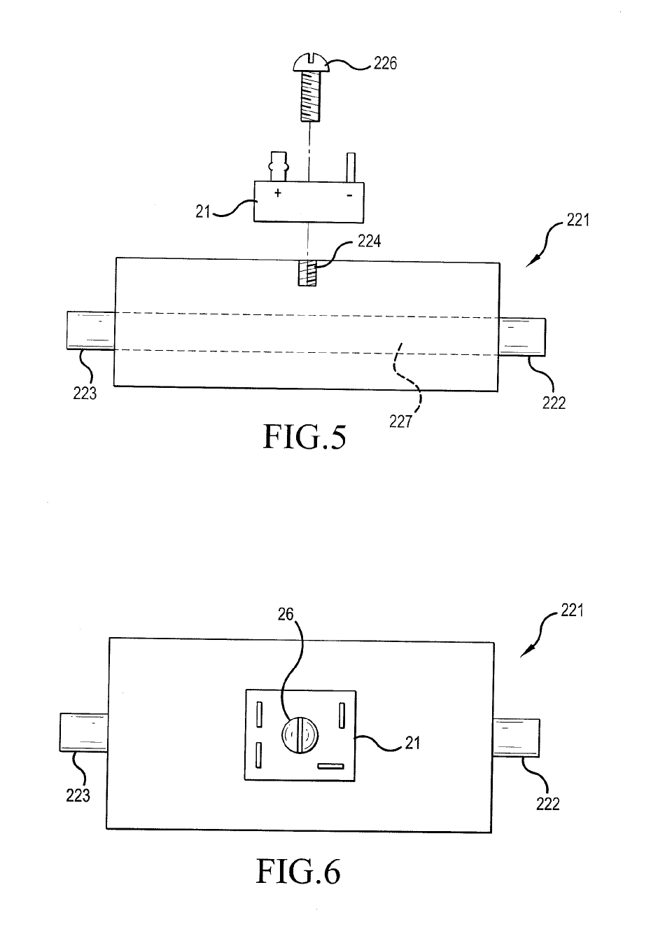

FIG. 19 is similar to FIG. 5 wherein like elements are referred to with the same reference numerals. Thus, a description thereof is omitted. As illustrated in FIG. 19, a thermoelectric device 800 is positioned within the reservoir 5 and is immersed in the electrolytic solution. In another embodiment, the thermoelectric device 800 may be positioned directly within the fuel cell 12 without the need for a reservoir. The thermoelectric device 800 can cool or heat the electrolytic solution depending on the needs of the user.

The thermoelectric device 800 can act as both a refrigerant as well as a heater. When voltage is applied to the positive terminal 810 and negative terminal 820, the device will act as a refrigerant for cooling the reservoir 5 or the fuel cell 12. The greater the voltage applied, the cooler the thermoelectric device 800 becomes. When the polarity is reversed to the thermoelectric device 800, the opposite reaction is created, causing the thermoelectric device 800 to act as a heater to heat up the reservoir 5 or the fuel cell 12. As the electrolytic solution comes in contact with the thermoelectric device 800 it will either be cooled or heated depending on the needs of the user. This is of particular importance if the liquid heater is to be used in extreme hot or cold climates. The use of the thermoelectric device 800 as a cooler or heater will maintain the electrolyte at the optimum temperature to maximize fuel output, and increase the life span of the anode.

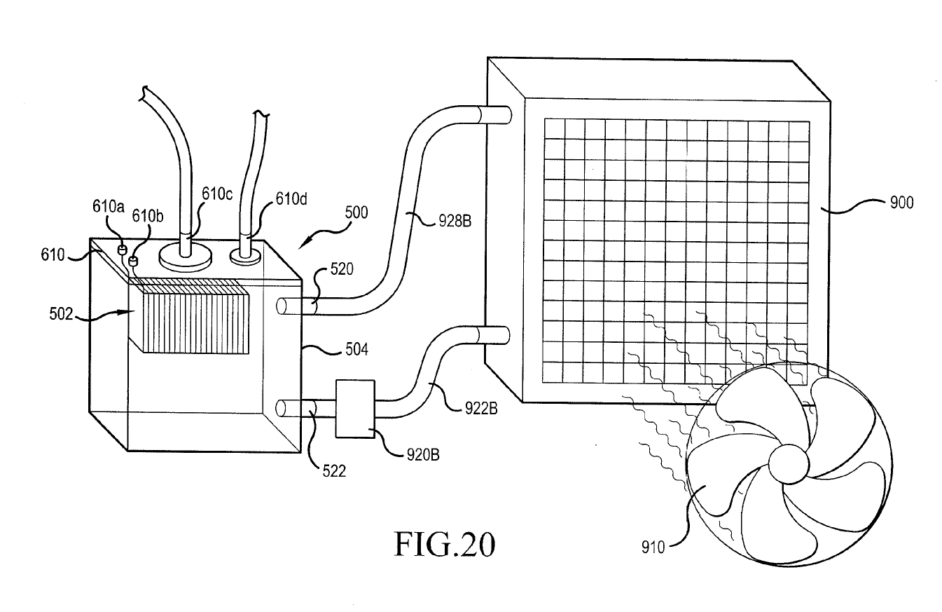

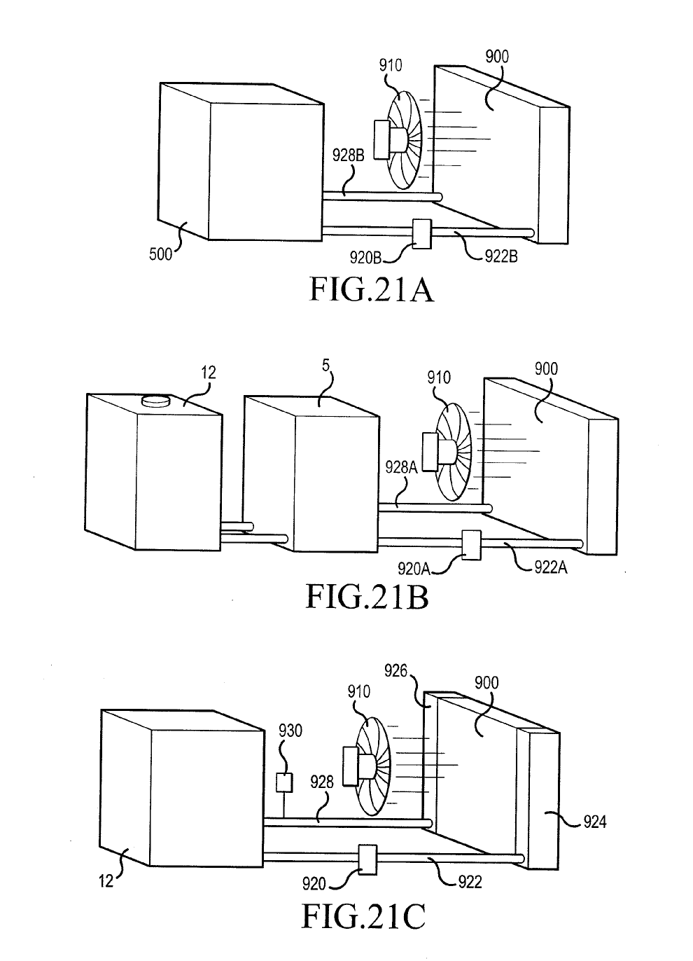

As illustrated in FIGS. 20, 21A and 21B, an air cooled radiator 900 and an electrically powered fan 910 are utilized for cooling the electrolytic solution within the integrated fuel cell assembly 500 or within the individual fuel cell 12 and reservoir 5.

As illustrated in FIG. 21C, depending on the size of the system and the amount of electrolytic solution required, the radiator 900 may act in place of the reservoir 5. A pump 920 pumps the electrolytic solution from the fuel cell 12 through the conduit 922 to a housing 924 on one side of the radiator 900 through the radiator 900 to a housing on the other side 926 of the radiator 900 and through the conduit 928 back to the fuel cell 12. Inside the radiator 900, the electrolytic solution flows into smaller conduits placed together in a grid configuration. The smaller conduits will be attached to thin veins wherein when air is passed over the smaller conduits the electrolytic solution inside the conduit is cooled. The air flowing over the veins will be supplied by an electric fan 910. The fan 910 is controlled by a thermostat 930 that will turn the fan 910 off and on to maintain optimum electrolyte temperature. The cooled electrolytic solution then flows back to the fuel cell 12.

As illustrated in FIG. 21B, the radiator 900 can be connected to the electrolytic reservoir 5 by a supply conduit 922A and a pump 920A operatively connected to a return conduit 928A. The embodiment illustrated in FIG. 21B will function in the same way as previously described except that the reservoir 5 is included in the supply of the electrolytic solution.

As illustrated in FIGS. 20 and 21A, the fuel cell 502 is positioned in the reservoir 504 with a supply conduit 922B connected to a pump 920B for supplying the electrolytic solution to the radiator 900. A return conduit 928B supplies the cooled electrolytic solution back to the reservoir 504. The reservoir 504 includes a hot electrolytic outlet 522 and a cooled electrolytic outlet 520. The reservoir top 610 includes the negative terminal connection 610a and the positive terminal connection 610b for securing to the positive and negative connections from the rectifier bridge 221. The reservoir top 610 also includes an H₂H₂O₂ vent conduit 610c for allowing H₂H₂O₂ fuel created by the cell 502 to exit and make its way through the system to be burned by the torch 17. The reservoir top 610 also includes a distilled water entry conduit 610d for allowing fresh distilled water to enter the fuel cell chamber from the distilled water tank 1.

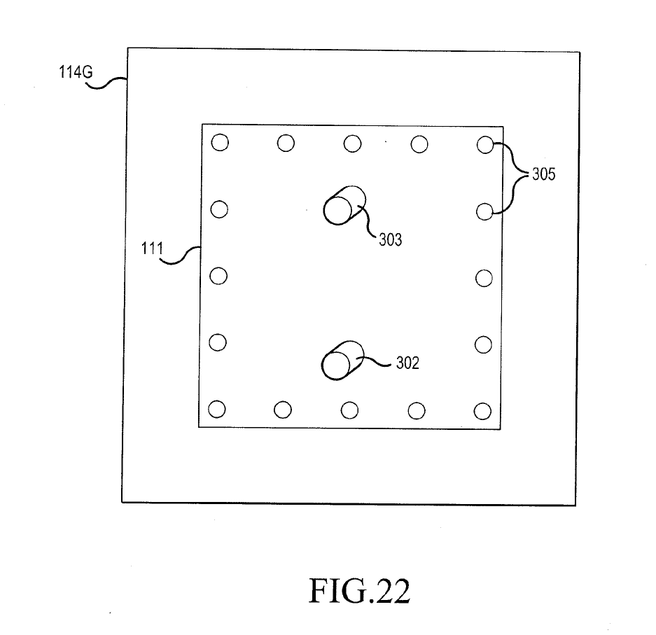

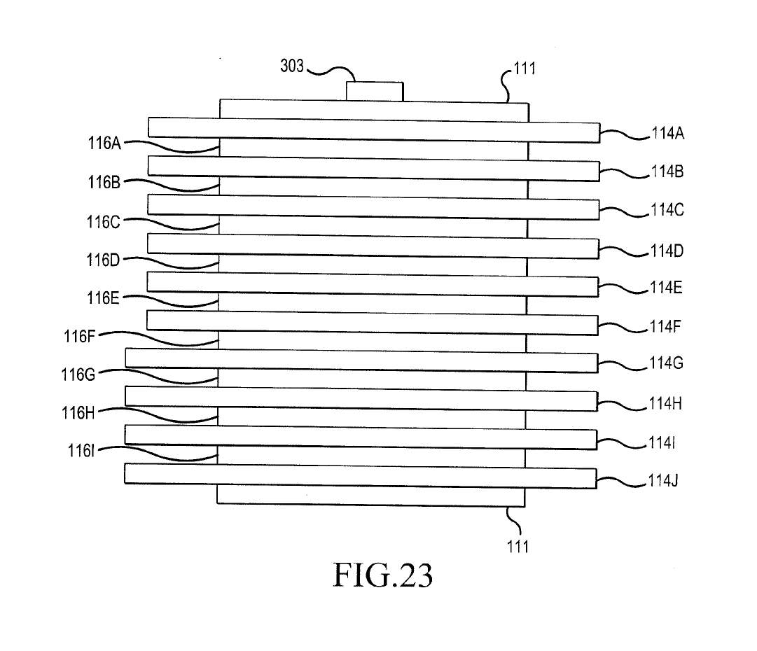

FIGS. 22 and 23 are similar to FIG. 8 wherein like elements are referred to with the same reference numerals. Thus, a description thereof is omitted. FIGS. 22 and 23 illustrate an embodiment for cooling the source of the heat in the electrolytic solution. More specifically, in FIG. 22 each of the positively and negatively charged plates 114A to 114G include a heat sink portion wherein each plate will extend through or past the walls of the two outside polymer plates 111 and will protrude from the edges in one or all directions. The plates 114A to 114G will remain minimally spaced by the gaskets 116A to 116I positioned between adjacent plates 114A to 114G. This configuration will create a heat sink device for drawing the heat out of the plates 114A to 114G and for transferring the heat to the air. The heat sink effect can be enhanced by adding an electrically powered fan that will force air over the heat sink increasing the cooling effect.

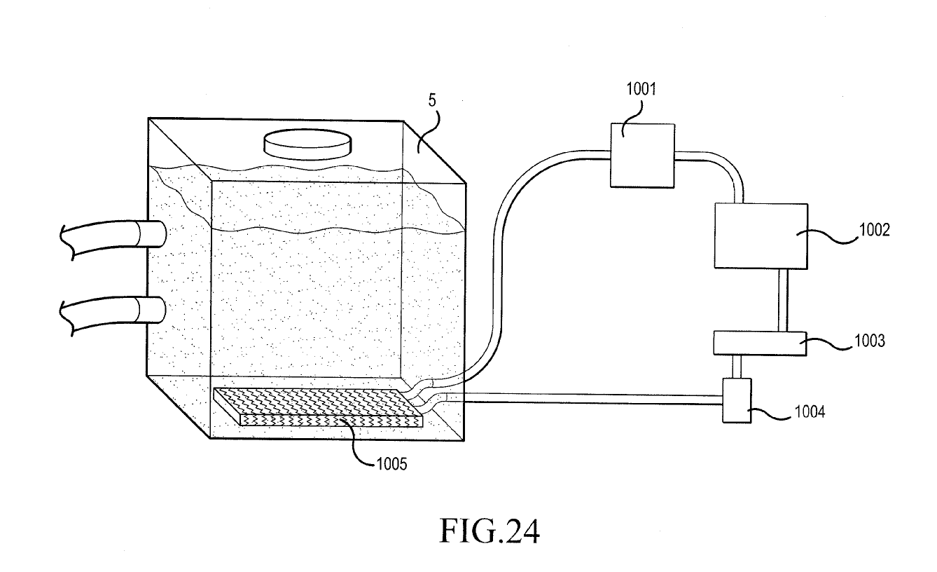

As illustrated in FIG. 24, a compressor 1001 may be employed to compress vapor to cool the electrolytic solution in the fuel cell 12 and or the reservoir 5. Compressed vapor cooling is commonly used in many forms of refrigeration and air conditioning systems. These systems include a compressor 1001, a condenser 1002, a dryer 1003, a metering device 1004, and an evaporator 1005. The evaporator 1005 is the component in the refrigeration system that becomes cold during the operation of the system. In this system the evaporator 1004 is positioned within the electrolyte reservoir 5 where the evaporator 1004 would cool the electrolytic solution to the desired temperature. The electrolytic solution is supplied to the reservoir 5 from the fuel cell 12 by way of a supply conduit and is returned as cooled electrolytic solution through a return conduit to the fuel cell 12.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A heating system for heating a liquid comprising:
a fuel cell supplied with electrolytic solution and water;
wherein the water in the electrolytic solution is converted to H₂H₂O₂ gas;
a torch for receiving the H₂H₂O₂ gas; and
a heat exchanger for receiving heat from the torch and heating a liquid.

2. The heating system according to claim 1, and further including a conduit for supplying the electrolytic solution to the fuel cell.

3. The heating system according to claim 1, and further including a manifold operatively connected to the torch for heating the liquid.

4. The heating system according to claim 1, wherein H₂H₂O₂ gas is not stored or pressurized but is generated based on the needs and the size of the heating system.

5. The heating system according to claim 1, wherein a high amount of energy for heating a liquid is produced relative to the amount of energy required to be supplied to the heating system.

6. The heating system according to claim 1, and further including a water conduit for supplying water to the fuel cell.

7. The heating system according to claim 1, and further including a bubbler for cleaning the H₂H₂O₂ gas prior to supplying the H₂H₂O₂ gas to the torch.

8. The heating system according to claim 1, and further including a reservoir for supplying water and recirculated electrolytic solution to the fuel cell.

9. The heating system according to claim 1, and further including a removable heat exchanger for allowing repairs and/or winterization of the heating system.

10. The heating system according to claim 1, and further including a by-pass to permit an adjustable or fixed amount of liquid to bypass the heat exchanger.

11. The heating system according to claim 1, and further including a system to allow for a variety of sources of electricity for the electrical input.

12. The heating system according to claim 8, and further including a water tank for supplying water to the reservoir.

13. The heating system according to claim 12, and further including a conduit operatively connected to a manifold positioned adjacent to said heat exchanger for supplying water generated by condensing steam formed in said manifold and for collecting water that will be a by-product from the combustion of the H₂H₂O₂ gas and for supplying the water to the water tank for supplying the water to the reservoir.

14. The heating system according to claim 7, and further including a dryer for drying the H₂H₂O₂ gas prior to supplying the H₂H₂O₂ gas to the torch.

15. The heating system according to claim 14, and further including a spark arrestor for preventing a flame from blowing back into the fuel cell from the torch.

16. The heating system according to claim 1, and further including a rectifier bridge for supplying current to charged plates in the fuel cell for converting the water to H₂H₂O₂ gas.

17. The heating system according to claim 1, and further including a cooling system for cooling the fuel cell.

18. The heating system according to claim 16, and further including a cooling system for cooling the rectifier bridge.

19. The heating system according to claim 1, wherein a plurality of torches are utilized for receiving H₂H₂O₂ gas for heating the liquid and a heat exchanger receives heat from the torches and heats the liquid.

20. A method for heating a liquid comprising the following steps:
providing a fuel cell supplied with electrolytic solution and water;
converting the water in the electrolytic solution into H₂H₂O₂ gas;
providing a torch for receiving the H₂H₂O₂ gas; and
providing a heat exchanger for receiving heat from the torch to heat a liquid.

21. The method for heating a liquid according to claim 20, and further including the step of supplying water to the fuel cell.

22. A heating system for heating a swimming pool or spa allowing the flow of water through an inlet and outlet pipe on the same side of a heating system or an inlet pipe on one side of the heating system and an outlet pipe on the other side.

23. A heating system for heating a liquid comprising:
a reservoir being divided into at least a first chamber and a second chamber;
a fuel cell positioned within said first chamber of said reservoir;
electrolytic solution and water being disposed within said first chamber of said reservoir for supplying electrolytic solution and water to said fuel cell;
a cooling fluid being disposed within said second chamber of said reservoir for cooling said fuel cell;
wherein the water in the electrolytic solution is converted to H₂H₂O₂ gas;
a torch for receiving the H₂H₂O₂ gas; and
a heat exchanger for receiving heat from the torch to heat a liquid.

24. The heating system for heating a liquid according to claim 23, and further including a reservoir top positioned on a top surface of said reservoir for closing said reservoir and a bracket secured to said reservoir top for positioning said fuel cell within said first chamber in said reservoir.

25. The heating system for heating a liquid according to claim 23, and further including a supply conduit with a shut off valve and an outlet conduit with a shut off valve operatively connected to said second chamber in said reservoir and a supply conduit with a shut off valve and an outlet conduit with a shut off valve operatively connected to said first chamber in said reservoir.

26. A heating system for heating a liquid comprising:
a fuel cell supplied with electrolytic solution and water;
a thermoelectric device for selectively cooling or heating the electrolytic solution;
wherein the water in the electrolytic solution is converted to H₂H₂O₂ gas;
a torch for receiving the H₂H₂O₂ gas; and
a heat exchanger for receiving heat from the torch to heat a liquid.

27. The heating system for heating a liquid according to claim 26, and further including a thermostat for controlling the cooling or heating of the electrolytic solution.

28. The heating system for heating a liquid according to claim 26, and further including a conduit for supplying electrolytic solution to the fuel cell.

29. The heating system for heating a liquid according to claim 26, and further including a manifold operatively connected to the torch for heating the liquid.

30. A heating system for heating a liquid comprising:
a fuel cell;
a reservoir for supplying electrolytic solution and water to said fuel cell;
a thermoelectric device for selectively cooling or heating the electrolytic solution;
wherein the water in the electrolytic solution is converted to H₂H₂O₂ gas;
a torch for receiving the H₂H₂O₂ gas; and
a heat exchanger for receiving heat from the torch and for heating a liquid.

31. The heating system for heating a liquid according to claim 30, and further including a thermostat operatively connected to said thermoelectric device for controlling the cooling or heating of the electrolytic solution.

32. A heating system for heating a liquid comprising:
a fuel cell supplied with electrolytic solution and water;
a radiator operatively connected to said heating system for cooling the electrolytic solution;
a fan for supplying a flow of air to said radiator for cooling the radiator;
wherein the water in the electrolytic solution is converted to H₂H₂O₂ gas;
a torch for receiving the H₂H₂O₂ gas; and
a heat exchanger for receiving heat from the torch to heat a liquid.

33. A fuel cell for use in a heating system for heating a liquid comprising:
a first outer plate having a predetermined length and width;
a second outer plate having a predetermined length and width;
a plurality of charged plates operatively positioned between said first outer plate and said second outer plate;
said plurality of charged plates being oversized relative to said first and second outer plates to include a heat exchange area that projects past the predetermined length and width of said first and second outer plates;
a conduit for supplying an electrolytic solution and water to said fuel cell; and
wherein the electrolytic solution and the water are disposed between said charged plates and the water in the electrolytic solution is converted to H₂H₂O₂ gas.

34. A heating system for heating a liquid comprising:
a fuel cell;
a reservoir for supplying electrolytic solution and water to said fuel cell;
an evaporator operatively positioned within said reservoir for cooling said electrolytic solution; and
a metering device, a dryer, a condenser and a compressor operatively connected to said evaporator for supplying a compressed gas for cooling said evaporator and for cooling the electrolytic solution.

35. A heating system for heating a liquid comprising:
a fuel cell;
a reservoir for supplying electrolytic solution and water to said fuel cell;
a thermoelectric device operatively positioned relative to said reservoir for selectively cooling or heating the electrolytic solution;
wherein water in the electrolytic solution is converted to H₂H₂O₂ gas; and
a removable safety catch drawer slidably positioned with a bottom of a heater cabinet and being located directly under the reservoir and or under the fuel cell, said heater cabinet including slots for allowing electrolytic solution from either the fuel cell or the reservoir to flow out of the heater cabinet and down into the drawer, said drawer including a neutralizing agent, supplied with the system or added subsequently, which when mixed with the electrolyte brings the ph to a neutral level for facilitating an easy cleanup of the electrolyte if the fuel cell and or the reservoir should rupture or leak.
